(19) United States
(12) Patent Application Publication
(10) Pub. No.: US 2010/0296752 A1
(43) Pub. Date: Nov. 25, 2010

(54) IMAGE PROCESSING

(75) Inventors: Todd Colin Pataky, Liverpool (GB); Robin Huw Crompton, Liverpool (GB); John Yannis Goulermas, Liverpool (GB)

Correspondence Address: MICHAEL BEST & FRIEDRICH LLP, 100 E WISCONSIN AVENUE, Suite 3300, MILWAUKEE, WI, 53202, US

(73) Assignee: ULIVE ENTERPRISES LTD., Liverpool (GB)

(21) Appl. No.: 12/808,235

(22) PCT Filed: Dec. 19, 2008
(86) PCT No.: PCT/GB2008/004185

§ 371 Date: Jun. 15, 2010

(30) Foreign Application Priority Data
Dec. 21, 2007 (GB) 0725094.7

(51) Int. Cl. G06K 9/36

(52) U.S. Cl. 382/276

(57) ABSTRACT

A method of processing a pressure image, the method comprising: receiving a plurality of first continuous pressure images; processing each of said first continuous pressure images to generate a respective second continuous pressure image; and generating a continuous statistical image representing a characteristic of the first pressure images by processing said second continuous pressure images.

The present invention relates to a method of image processing and more particularly to a method for pedobarographical statistical analysis.

Techniques for processing images so as to obtain clinically valuable data are widely used in various areas of medicine. Different areas of medicine are concerned with processing of images representing different parts of the human body. The nature of the images used and the clinical information desired from processing of the images is such that different techniques are used in different areas of medicine.

Pedobarography is a two-dimensional medical imaging technique that processes and compares pressure fields acting on the plantar surface of a subject's foot during the stance phase of gait and during postural tasks. Pedobarography is used in a variety of clinical applications including post-operative assessment, arthritis monitoring, orthotics design and diabetic neuropathy detection and management.

Pedobarographic image data is typically obtained by suitably converting data taken from pressure sensors located beneath a subject's foot. The pressure sensors are arranged so as to provide a variable output indicative of the pressure applied by the foot in a particular region. The pressure sensors provide values for pixels within the generated image data. The number of pressure sensors, their spacing and their size determines the resolution of the image data. Images which are obtained in this way typically have sub-centimetre resolution.

Current methods of analysing pedobarographical images employ either qualitative visual assessment or one of a variety of subsampling techniques which process an image in a plurality of discrete parts.

While visual assessment of images can be effective, it is typically time consuming and highly subjective. Additionally, effective visual assessment can only be carried out by appropriately trained individuals.

The existing subsampling techniques used for analysing pedobarographical images segment raw pedobarographical data and label the segmented data according to anatomical region thereby allowing for automatic, or semi-automatic isolation of commonly labelled regions. Statistical tests can then be conducted within and/or between labelled regions.

While more objective than visual assessment, subsampling techniques suffer from a number of disadvantages. Given that the plantar surface of the foot is continuous, not discrete, subsampling destroys data and ultimately provides a low-resolution view of the continuous foot-ground interaction. Subsampling techniques are typically only concerned with the comparison of particular regions of pedobarographic images rather than the foot as a whole.

It is an object of the present invention to obviate or mitigate one or more of the problems outlined above.

According to a first aspect of the present invention, there is provided a method of processing pressure images, the method comprising, receiving a plurality of first continuous pressure images, processing each of the first continuous pressure images to generate a respective second continuous pressure image and generating a continuous statistical image representing a characteristic of the first pressure images by processing said second continuous pressure images.

An advantage of the first aspect is that a continuous statistical image is generated thereby allowing statistical analysis to be performed on the continuous pressure images, rather than on discrete, subsampled portions of the pressure images.

The processing may comprise applying a smoothing operation to the first pressure images.

The smoothing may comprise filtering the received images, optionally applying a predetermined threshold to the filtered images, and optionally performing morphological operations on the images to which the predetermined threshold has been applied. Morphological operations may include, for example, morphological opening and closing.

The processing may comprise registering the first pressure images to a template image.

Registering the first pressure images to a template image may comprise performing at least one of a translation and rotation of the first pressure images. Registering the first pressure images may also comprise generating initial registration parameters and optimising said initial registration parameters. The parameters may define either a linear or a nonlinear spatial transformation. Linear transformations may comprise steps such as applying shearing affine transformations, linear spatial warping and general projective transformations. Nonlinear transformations may comprise steps such as applying parameterized nonlinear spatial warping transformations to the first pressure images.

Spatial warping may comprise scaling the pressure image, and the scaling may apply respective scaling factors in two perpendicular directions.

The characteristic of the first pressure images may be a comparison with one or more predetermined reference images.

The characteristic of the first pressure images may be a comparison of the first pressure images.

The plurality of first continuous pressure images may be taken from a single subject or from a plurality of subjects.

Generating data may comprise generating a continuous image representing a characteristic of the first pressure images. The generated image may have substantially the same resolution as the first pressure images. For example, where the characteristic is a comparison, the generated image may be a comparison image. The comparison image may have a resolution which is substantially equal to the or each first pressure image. Such a comparison image allows convenient comparison of the or each first pressure image.

The generated continuous statistical image may be a t-map, F-map, or other statistical map produced by means of a general linear statistical model of a plurality of images.

The method may further comprise processing the statistical image to generate a further statistical image. Generating a further statistical image may comprise carrying out statistical inference on the statistical image. The further statistical image may be a stepwise continuous statistical inference image representing statistical significance of a characteristic of a plurality of first continuous pressure images.

Statistical inference may process t values of the statistical image generated by at test and generate probability values.

The statistical inference may take into account smoothness of the statistical image and/or at least one geometric property of the statistical image.

The statistical inference may comprise techniques based upon random field theory, a Bonferroni correction, and/or non-parametric inference.

The first continuous pressure images may be plantar foot surface pedobarographic images and each of the first plantar foot surface pedobarographic images and the second plantar foot surface pedobarographic images may be an image of the entire plantar foot surface. Where the first pressure images are plantar foot surface pedobarographic images, the present invention has the advantage that statistical analysis is performed on the continuous plantar foot surface rather than discrete segments of the foot surface, as is the case with existing subsampling techniques.

The method may further comprise generating a plurality of statistical images each representing a characteristic of one or more pressure images, receiving an input pressure image, and selecting one of the plurality of statistical images based upon the input pressure image.

The first continuous pressure images may be images of pressure fields between a first object and a second object

The first continuous pressure images may be images of pressure fields between a subject and a mattress.

The first continuous pressure images may be images of pressure fields between a subject and a seating apparatus.

A second aspect of the present invention provides a method for displaying dynamic pressure data, such data comprising consecutive time samples of two-dimensional pressure images, the method comprising displaying a three dimensional volumetric representation of said pressure data, wherein each volume consists of two spatial and one temporal dimension.

A third aspect of the present invention provides a method for displaying pressure data comprising a plurality of sets of two-dimensional pressure data, the method comprising displaying a three dimensional volumetric representation of the pressure data, wherein first and second dimensions of the three dimensional volumetric representation represent spatial data, and a third dimension of said three dimensional volumetric representations represents temporal data.

The method may further comprise graphically rendering the three dimensional volumetric representation.

The method may further comprise computing surfaces from the data representing a predetermined pressure or range of pressures, and generating graphical data indicating the determined surfaces.

The three dimensional volumetric representation may be a three dimensional statistical image generated from a plurality of the pressure data.

The invention can be implemented in any convenient way including by means of a suitable apparatus. Such an apparatus can be a computer which is programmed to carry out the method set out above. The invention further provides a computer program arranged to carry out the method set out above. Such a computer program can be carried on an appropriate carrier medium which can be a tangible carrier medium (such as a hard disk drive or CD-ROM) or alternatively an intangible carrier medium such as a communications signal.

It will be appreciated that features described in the context of one aspect of the present invention may be applied in the context of any other aspect of the invention.

An embodiment of the present invention will now be described, by way of example, with reference to the accompanying drawings, in which:

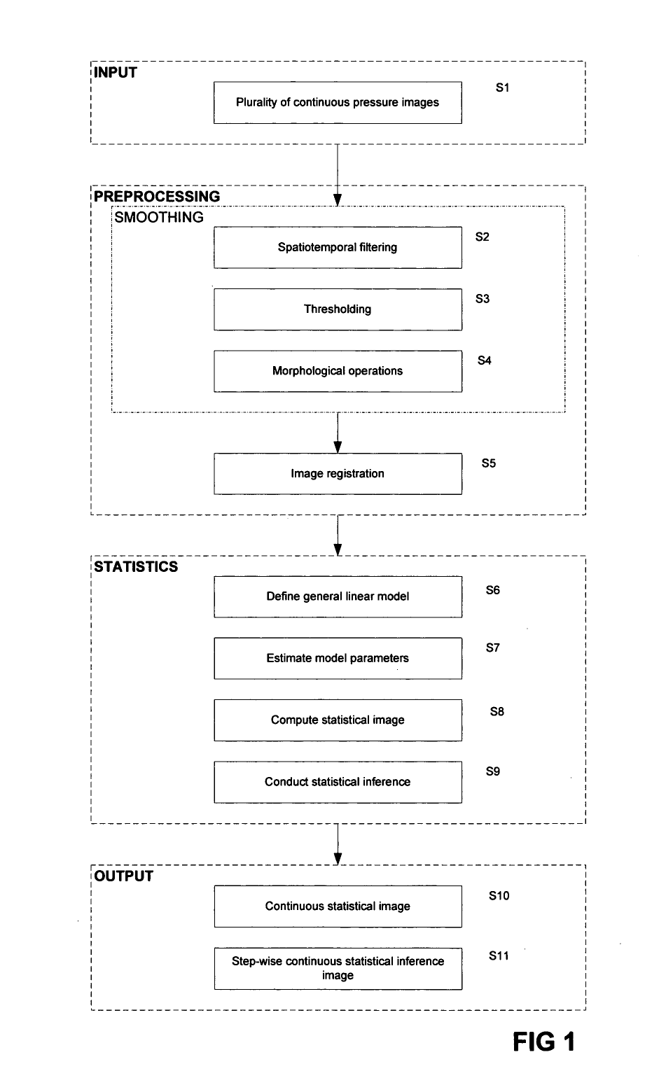

FIG. 1 is a flowchart of processing carried out in an embodiment of the invention;

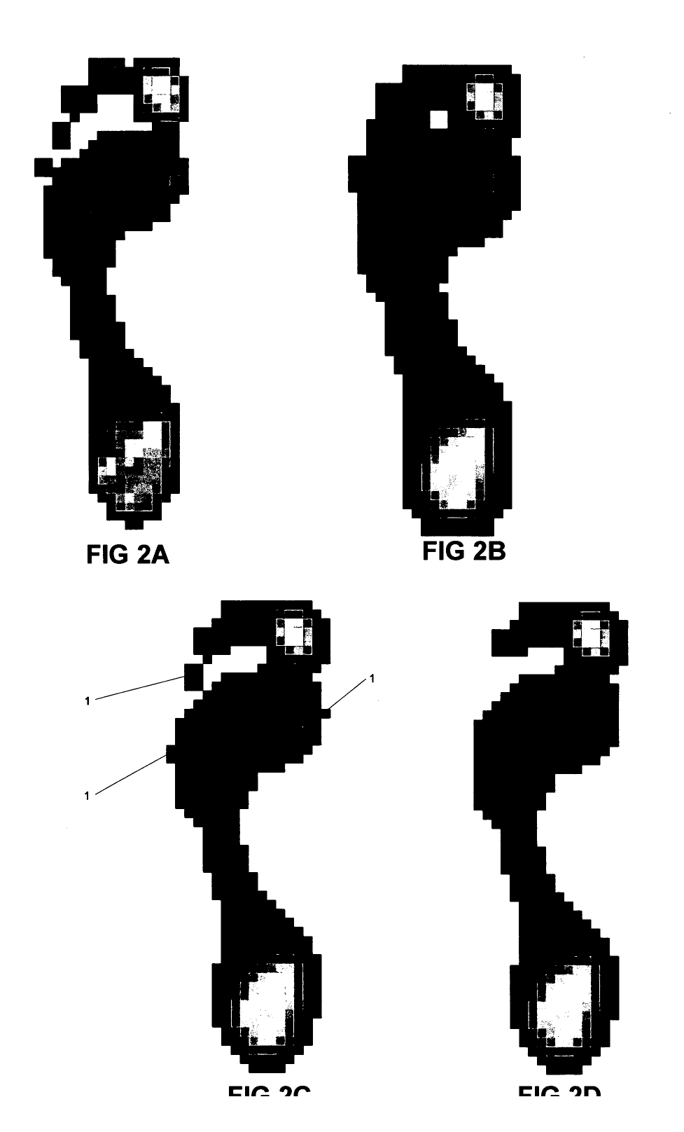

FIG. 2A is an example of a pedobarographical image processed using the processing of FIG. 1;

FIG. 2B is the pedobarographical image of FIG. 2A after a filtering operation carried out as part of the processing of FIG. 1;

FIG. 2C is the image of FIG. 2B after a thresholding operation carried out as part of the processing of FIG. 1;

FIG. 2D is the image of FIG. 2C after a morphological opening operation carried out as part of the processing of FIG. 1;

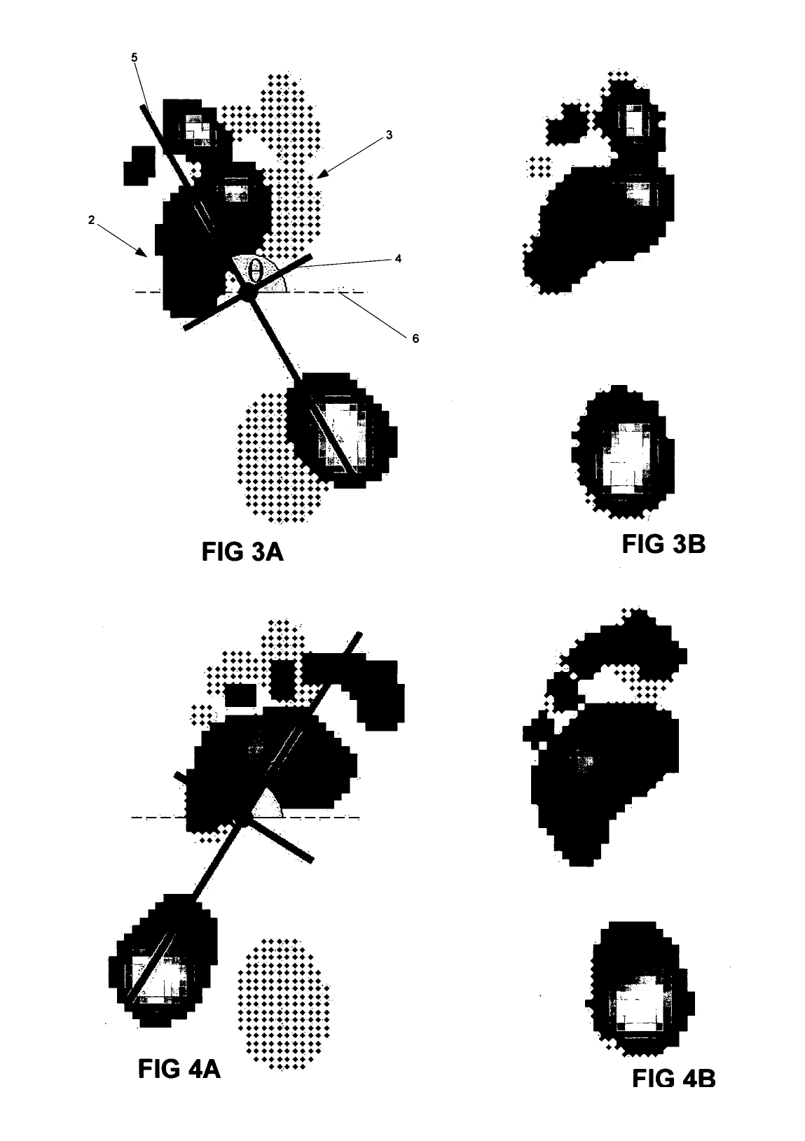

FIGS. 3A and 3B show registration of a foot image representing walking with an abducted foot posture;

FIGS. 4A and 4B show registration of a foot image representing walking with an adducted foot posture;

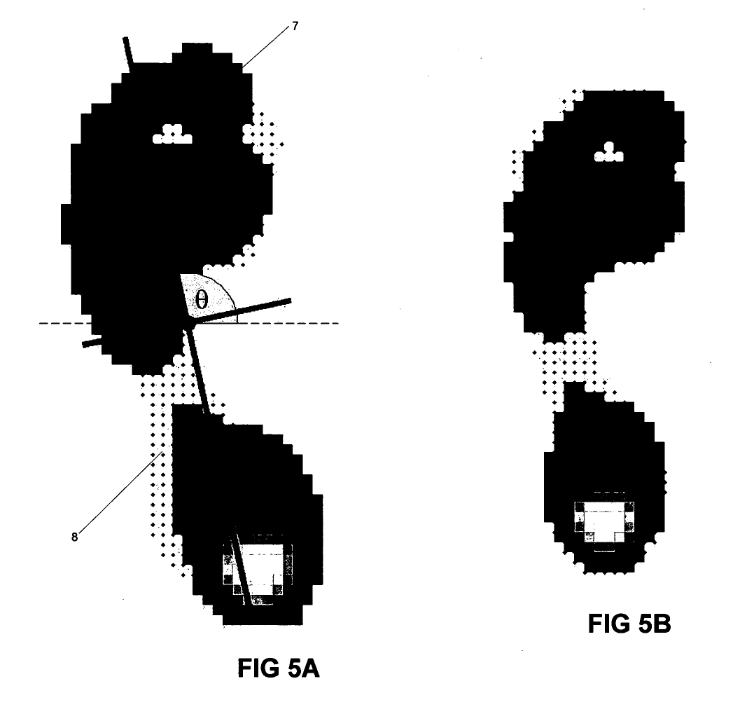

FIGS. 5A and 5B illustrate registration via a spatial warping processes;

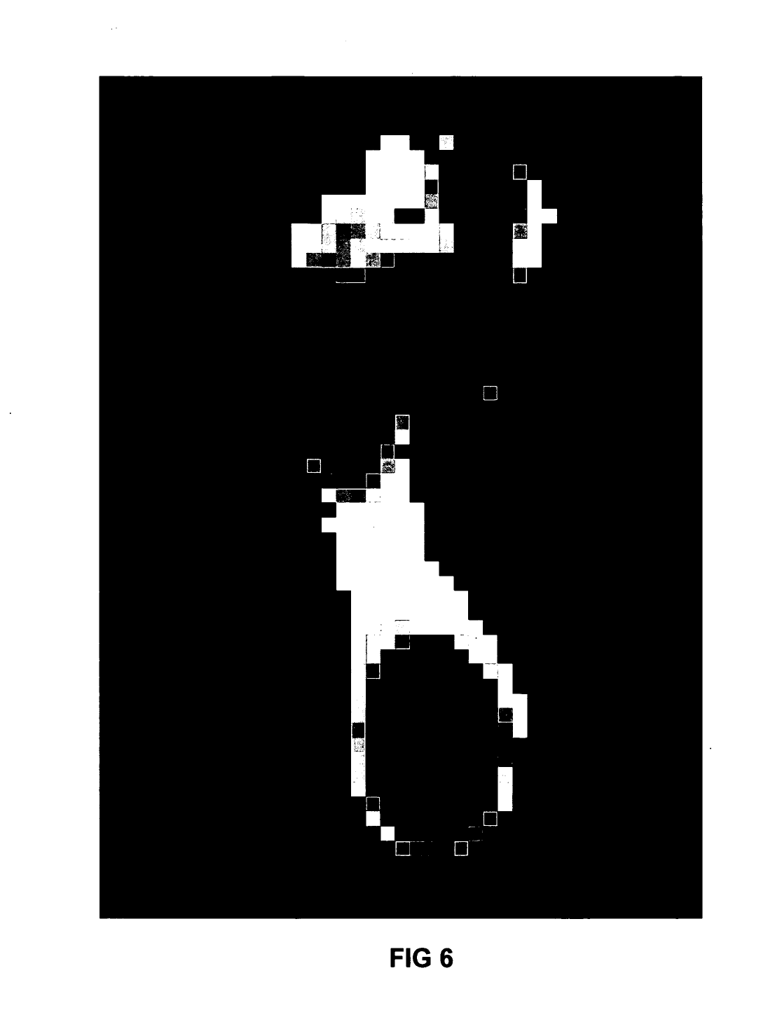

FIG. 6 is an image showing registration accuracy across a sequence of experimentally obtained images;

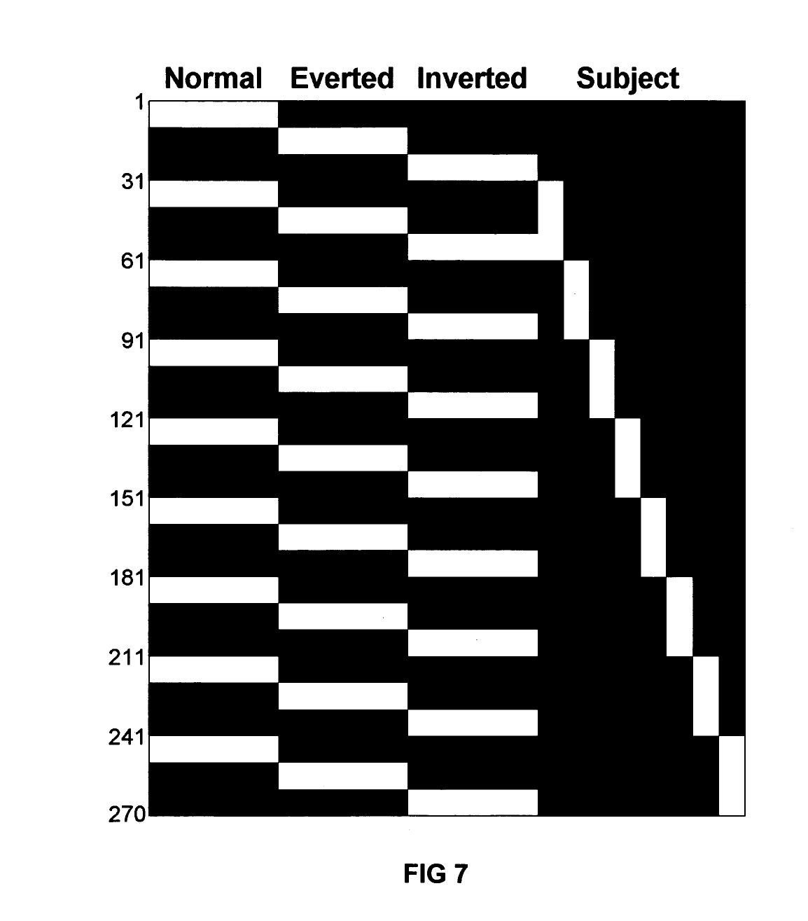

FIG. 7 is an example experimental design matrix;

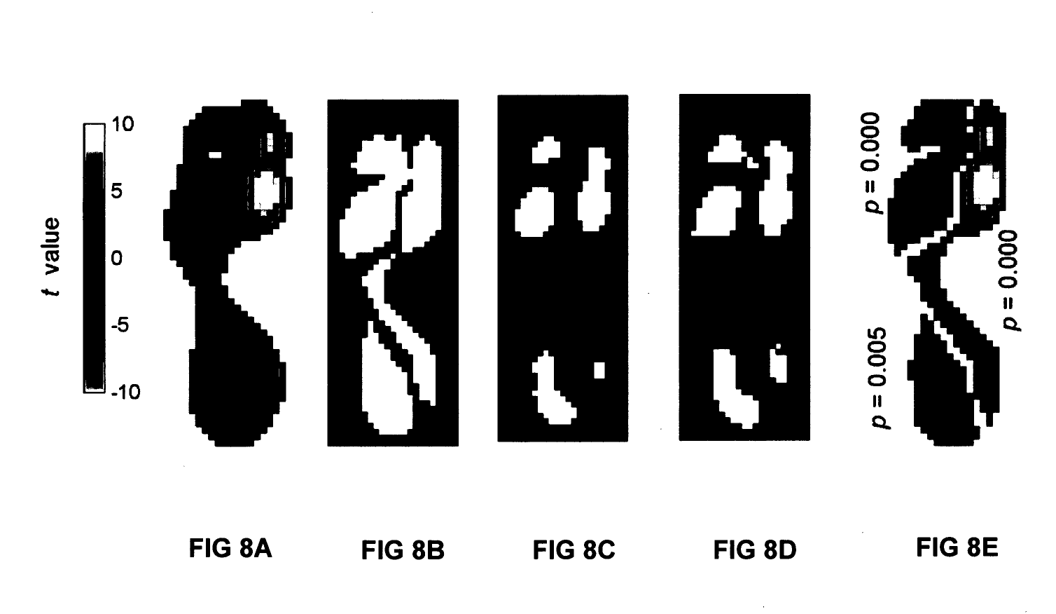

FIGS. 8A to 8E show statistical images generated using a plurality of statistical inference methods;

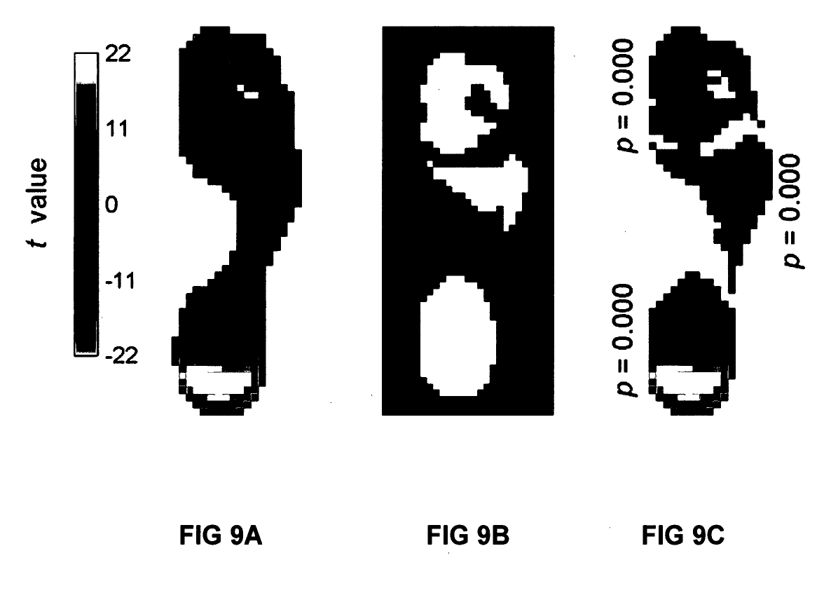

FIGS. 9A to 9C show statistical images generated using random field theory;

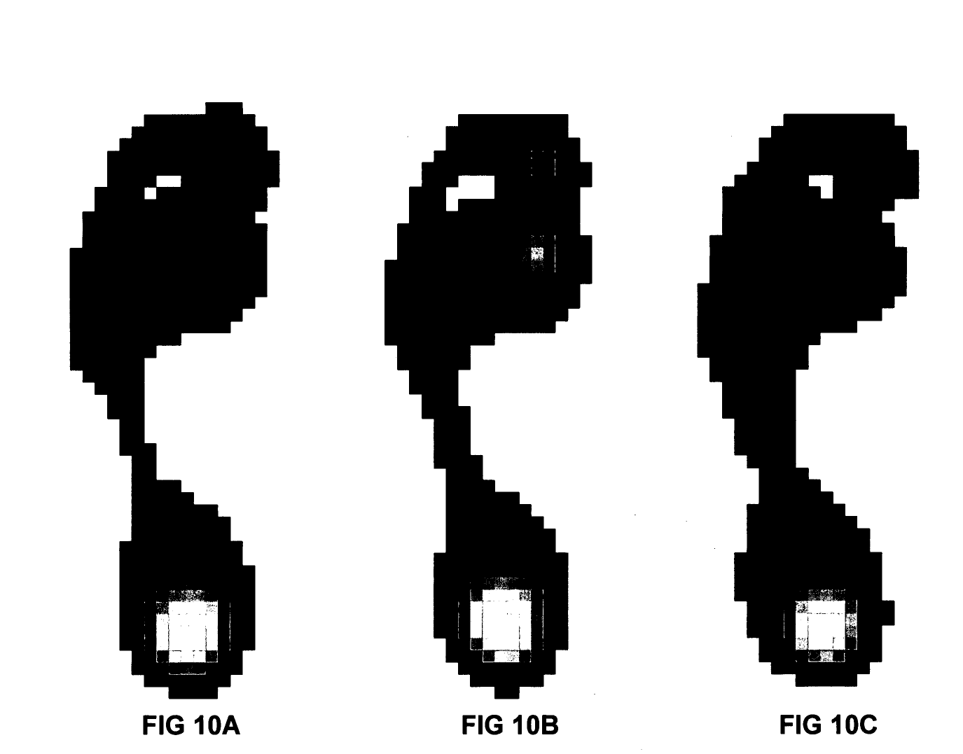

FIGS. 10A to 10C show mean images obtained in differing experimental conditions of normal walking, abducted walking, and adducted walking, respectively;

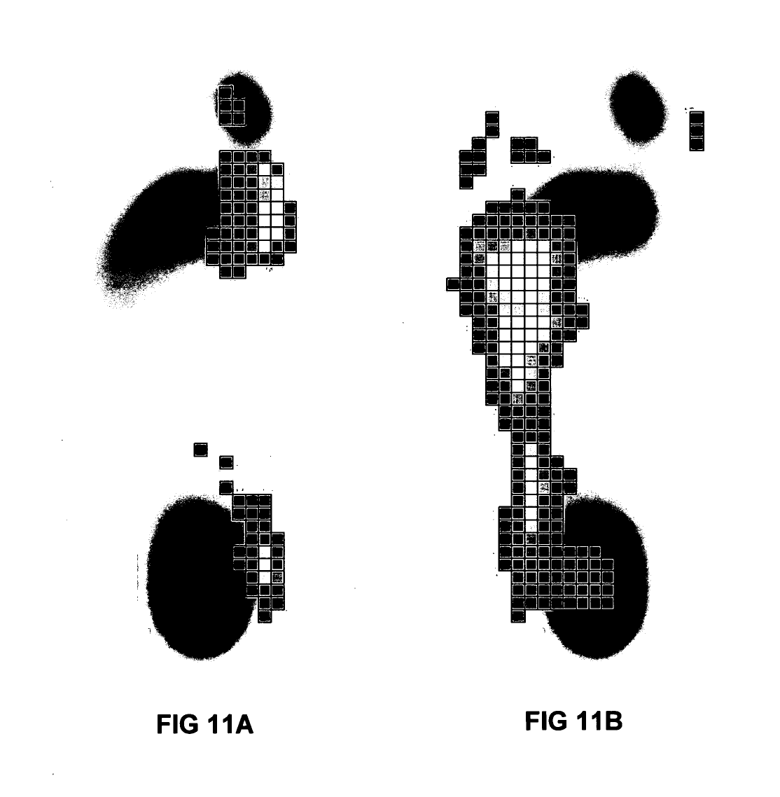

FIGS. 11A and 11B respectively show the statistical comparison of images obtained representing abducted walking with normal walking and adducted walking with normal walking;

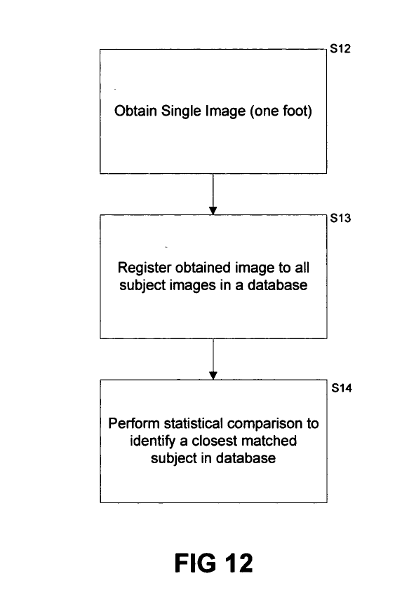

FIG. 12 is a flow chart showing use of the methods described herein in the identification of individuals;

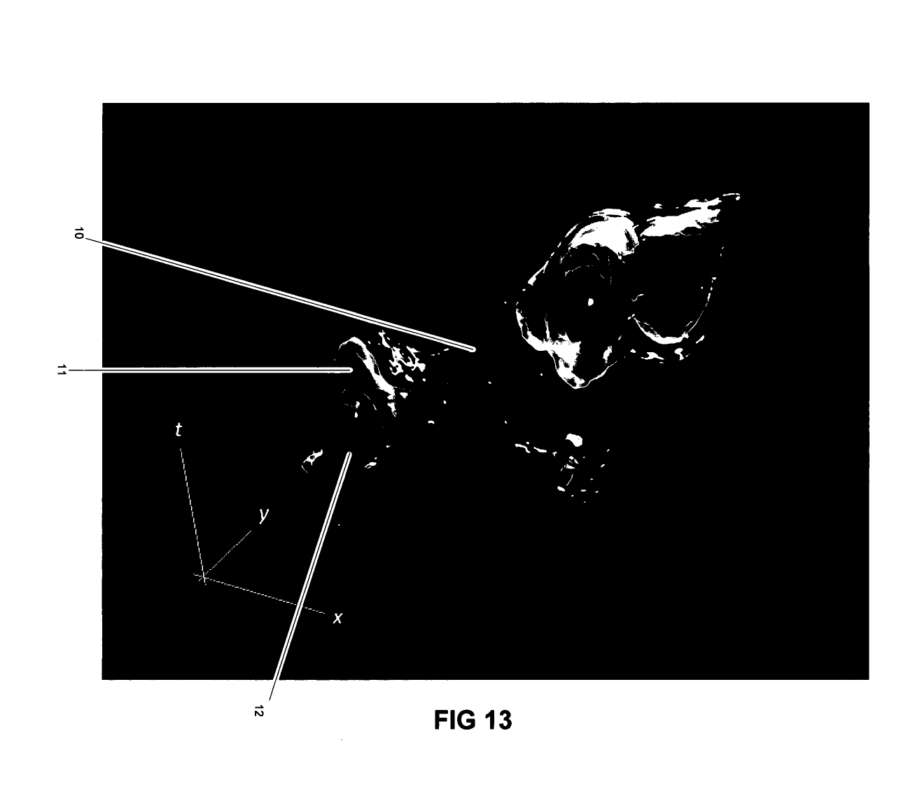

FIG. 13 is a spatiotemporal volumetric visualization of pedobarographic data using isosurfaces;

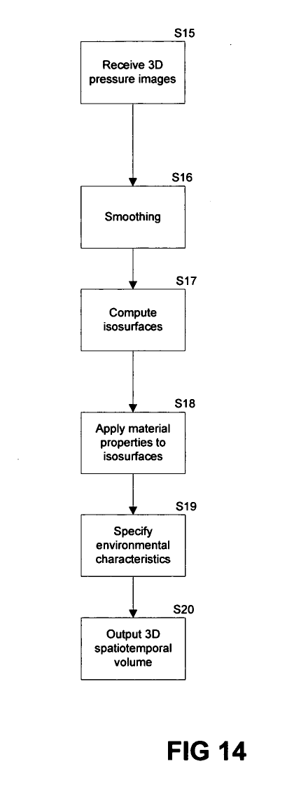

FIG. 14 is a flow chart of processing carried out to generate a volumetric visualization of pedobarographic data; and

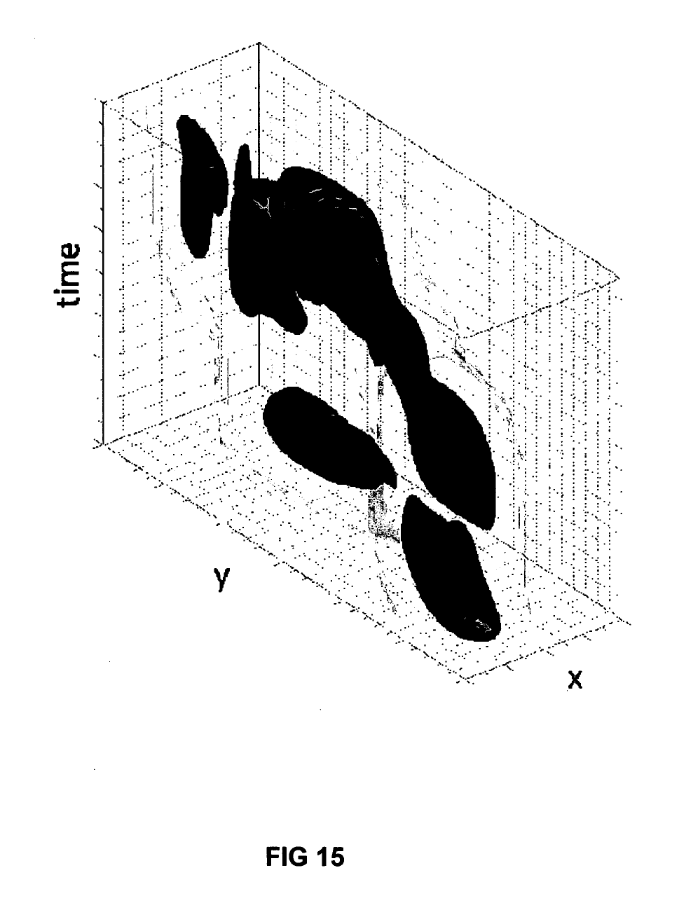

FIG. 15 is a volumetric visualization of a three-dimensional spatiotemporal statistical image.

Embodiments of the present invention use pixel-by-pixel or voxel-by-voxel statistical image comparison to provide a method of automating the process of analysing pedobarographical data.

Pixel-by-pixel comparisons are mathematically identical to voxel-by-voxel comparisons and thus the term ‘pixel’ is used herein to represent both the two-dimensional pixel and the three-dimensional voxel.

A statistical image, for the purposes of the following description, relates to an image in which each pixel embodies a single statistical value. For example, a particular pixel value at a particular position within the statistical image may parameterise a statistical distribution of pixels at that same position across a plurality of images.

In order to obtain pedobarographical data, sensor values output from sensors located beneath a subject's foot are obtained. For example, each sensor may be associated with a single pixel of the generated pedobarographical data, such that each sensor's output value determines a pixel value for a respective pixel. In a preferred embodiment, a plurality of sensor values are obtained from each sensor and a maximum sensor value is used to determine a pixel value for the respective pixel, although other techniques can be used.

In some embodiments of the invention, instead of having a direct one-to-one mapping between pressure sensors and pixels, some pre-processing is carried out to relate sensor values to pixel values. For example, where sensors of size 5.08 mm×7.62 mm are used, the pressure sensor values may be resampled onto a square Cartesian grid using bilinear interpolation or other interpolation method so as to generate pixel values at virtual coordinates of, for example, 5.08 mm×5.08 mm.

In some embodiments of the invention, the images may be three-dimensional pressure images, where the third dimension is time.

It is desired to compare a plurality of images. Clinically useful data can be obtained by comparing a plurality of images obtained from a single subject (intra-subject comparison) and by comparing a plurality of images obtained from different subjects (inter-subject comparison). Before comparing images from different subjects on a pixel-by-pixel basis it is necessary to transform each image to a common template image such that each image has common size, shape and orientation.

FIG. 1 illustrates processing carried out on an input image. At step S1 a plurality of input images are received, each comprising a plurality of pixels, each pixel having an associated pixel value. An example input image of a left foot is shown in FIG. 2A, where lighter pixels indicate areas of higher pressure. The processing of an input image is now described. It will be appreciated that each input image is similarly processed.

As the plantar surface of the foot is continuous and compliant, there should be no sharp changes in pressure between neighbouring pixels such that smoothing the image will not result in detrimental loss of information, but will remove undesirable artefacts within an input image and increase the signal-to-noise ratio. The image may be smoothed using any smoothing method known to those skilled in the art.

In the embodiment of the invention shown in FIG. 1 the input image is smoothed by a combination of filtering (step S2), thresholding (step S3) and morphological operations (step S4).

At step S2 each input image is filtered with, for example, a symmetric convolution kernel of three-pixel diameter (˜1.5 cm), biasing the centre pixel by a factor of two. FIG. 2B shows the results of applying the symmetric convolution kernel as described above to the image of FIG. 2A.

It can be seen that a side effect of the filtering process is to add pixels around the periphery of the foot and thus artificially inflate the foot contact area. Therefore, having filtered the input image at step S2 of FIG. 1, a threshold is applied to the resulting image shown in FIG. 2B at step S3 so as to generate the image shown in FIG. 2C. The applied threshold removes pixels peripheral to the foot. The threshold is arranged to remove any pixels corresponding to pressure values that are beneath a predetermined threshold pressure, the threshold pressure being selected to be indicative of pixel values of pixels peripheral to the original foot contact area.

Referring to FIG. 2C it can be seen that application of the threshold at step S3 results in the presence of spur pixels 1 in the low-pressure regions of the lateral phalanges. Isolated and spur pixels are liable to affect the statistical analysis and it may be desirable that these should be removed from the template image by way of morphological opening. Such opening is carried out at step S4 and results in the generation of the image shown in FIG. 2D.

The preceding description has been concerned with smoothing an input image to remove any artefacts within an input image. Smoothing the input images enhances the signal-to-noise ratio and can help to facilitate subsequent steps in the method, which are described in further detail below with reference to FIG. 1. It will however be appreciated that smoothing is not an essential aspect of the method as described herein.

In order to allow images to be properly compared, the input image is registered to a common template at step S5 so as to cause the input images to align on a common template. Further, if intra-subject pedobarographical data is obtained over a relatively short time period (such that the dimensions of a subject's feet do not change), aligning to a common template allows for intra-subject analysis without further transformation of the pedobarographic images. One method of realignment that may be used in embodiments of the present invention is described below.

The registration process involves a combination of a translation of the input image to a given position, a rotation of the image, a further translation to return the input image to its initial position before a final translation of the rotated image.

Taking three generalized parameters as elements of a vector q, a transformation sequence T(q) may be defined:

$$\begin{matrix}q = [ \begin{matrix}{q}_{1} \\ {q}_{2} \\ {q}_{3}\end{matrix} ] & ( 1 ) \\ {U}_{0} = [ \begin{matrix}1 & 0 & 0 \\ 0 & 1 & 0 \\ - {x}_{c} & - {y}_{c} & 1\end{matrix} ] & ( 2 ) \\ R = [ \begin{matrix}cos {q}_{3} & sin {q}_{3} & 0 \\ - sin {q}_{3} & cos {q}_{3} & 0 \\ 0 & 0 & 1\end{matrix} ] & ( 3 ) \\ {U}_{1} = [ \begin{matrix}1 & 0 & 0 \\ 0 & 1 & 0 \\ {q}_{1} & {q}_{2} & 1\end{matrix} ] & ( 4 ) \\ T ( q ) = {U}_{0} {RU}_{0}^{- 1} {U}_{1} & ( 5 )\end{matrix}$$

where:
(x_{c}, y_{c}) are the coordinates of the foot centroid; q₁ and q₂ indicate a translation of the image in the horizontal and vertical directions, respectively; and
q₃ indicates a rotation of the image;

The transformation sequence (5) translates the image to the origin as indicated by the matrix (2), rotates the image about its centroid as indicated by the matrix (3), and translates the rotated image back to its original position as indicated by the inverse of the matrix (2). The rotated image is then translated to an arbitrary position as indicated by the matrix (4).

The transformation sequence (5) is concerned with re-positioning pixels of an image. Therefore, if an image is represented by a vector p a transformed image with appropriate pixel values p′ is given by equation (6):

p′=p(XT) (6)

where:
X is a (3xJ) array of J pixel coordinates in homogenous form (i.e. with a dummy row of ones added to permit matrix multiplication).

FIG. 3A shows an image 2 taken from a subject walking with an abducted foot posture. A template image 3 with which the image 2 is to be aligned is also shown.

FIG. 3A shows the major principal axis 4 and the minor principal axis 5 of the image 2. An angle θ denotes the orientation of the minor principal axis 5 of the image 2 relative to a reference axis 6. FIG. 3B shows the result of registering the image 2 to the template image 3.

FIGS. 4A and 4B correspond to FIGS. 3A and 3B but relate to an image of a foot taken from a subject walking with an adducted foot posture.

Given a source image p₁ and a template image p₀ with which the source image is to be registered, a vector q is determined which provides an optimal transformation. Taking advantage of foot geometry, an initial estimate of q, q⁽⁰⁾ can be made according to equation (7):

$${q}^{( 0 )} = [ \begin{matrix}{x}_{c 0} - {x}_{c 1} \\ {y}_{c 0} - {y}_{c 1} \\ {θ}_{0} - {θ}_{1}\end{matrix} ] \qquad ( 7 )$$

where:
(x_{c0}, y_{c0}) is the centroid of the foot in the template image p₀;
(x_{c1}, y_{c1}) is the centroid of the foot in the source image p₁;
θ₀ is the orientation of the minor principal axis of the foot in the template image p₀ relative to a reference axis; and
θ₁ is the orientation of the minor principal axis of the foot in the template image p₁ relative to a reference axis.

The principal axes can be computed as the eigenvectors of the ‘inertia’ matrix of a pressure image (i.e. where pixel values represent local ‘mass’), or from a binary image (i.e. where all pixels have equal ‘mass’). The minor principal axis is the axis about which there is minimal inertial moment.

q⁽⁰⁾ can be used in to define a sequence of transformations as represented by equation (5), and the sequence of transformations can be applied to the source image pᵢ as indicated by equation (6) to provide a transformed source image p₁′. The template image p₀ and the transformed source image p₁′ may now be directly compared using a dissimilarity metric ε:

ε=(p₁′−p₀)^{T}(p₁′−p₀) (8)

where ε is the sum of the squared differences between the elements of the two images and where the superscript ‘T’ indicates vector transpose.

The registration goal can now be stated formally as:

Minimize ε(q):qεΩ⊂ [symbol] ³ (9)

The optimisation problem (9) is unbounded and unconstrained in 3D parameter space Ω. Optimisation can be implemented using any optimisation technique. The objective function of equation (8) is convex in the vicinity of the initial estimate q₍₀₎ given by equation (7). Thus the optimisation can be implemented using a quasi-Newton steepest descent gradient search, for example.

Although image registration is a computationally demanding technique, taking advantage of foot geometry as indicated above allows a good initial approximation to be generated so as to achieve successful registration with relatively simple optimisation techniques. A simple gradient search technique has been found to provide satisfactory convergence in a small data set. That said, a gradient search using sum of squares error may not be effective for a wider range of subjects and/or for stereotypical pressure profiles, especially because the objective function of equation (8) has been found to be convex only in small regions around the initial approximation. Other approaches such as such sparse gradient optimisation and binary shape registration may be more appropriate for a generalised registration approach.

With a set of images aligned to a common template, it is possible to conduct pixel-by-pixel statistical analysis on intra-subject images but differences in the shape between the feet of subjects mean that it is desirable to spatially normalize images prior to conducting any inter-subject analysis as part of the registration performed at step S5 of FIG. 1. Spatial warping can be achieved through registering a source image from one subject to a template image chosen arbitrarily from another subject. A five parameter non-shearing affine transformation can be used to normalize the width and length of the foot images as measured along the principal axes. In order to apply such a transformation, the transformation sequence given by equation (5) is modified to be:

T(q)=U₀R_{V}SR_{V}⁻¹RU_{V}⁻¹U₁ (10)

where

$$\begin{matrix}{R}_{V} [ \begin{matrix}cos ( π / 2 - θ ) & sin ( π / 2 - θ ) & 0 \\ - sin ( π / 2 - θ ) & cos ( π / 2 - θ ) & 0 \\ 0 & 0 & 1\end{matrix} ] & ( 11 ) \\ S = [ \begin{matrix}{q}_{4} & 0 & 0 \\ 0 & {q}_{5} & 0 \\ 0 & 0 & 1\end{matrix} ] & ( 12 )\end{matrix}$$

and U₀, R, and U₁ are given by (2), (3), and (4), respectively.

Here, the vector q has five elements, the first three elements being as described above, and the two additional elements q₄ and q₅ indicating respective scaling factors for the width and length of the foot image. The transformation sequence of equation (10) represents a form of linear spatial warping, which can scale the width and length of the foot by unequal amounts (if q₄≈q₅).

Rᵥ, given by matrix (11), rotates the foot to a vertical orientation so that the matrix (12) S can scale the width by a factor q₄ and length by a factor q₅. A good starting value from which optimisation may proceed, q⁽⁰⁾ may be given by:

$${q}^{( 0 )} = [ \begin{matrix}{x}_{c 0} - {x}_{c 1} \\ {y}_{c 0} - {y}_{c 1} \\ {θ}_{0} - {θ}_{1} \\ {w}_{0} / {w}_{1} \\ {l}_{0} / {l}_{1}\end{matrix} ] \qquad ( 13 )$$

where:
l₀ and l₁ are the foot lengths of the template image p₀ and the source image p₁ respectively as measured along the minor principal axis 5; and
w₀ and w₁ are the foot widths of the template image p₀ and the source image p₁ respectfully as measured along the major principal axis 4.

q⁽⁰⁾ can be used in equation (10) to transform the source image p₁ according to equation (6) so as to give a transformed source image p₁′. The template image p₀ and the transformed source image p₁′ can now be directly compared according to equation (8) so that the value of the vector q can be optimized according to equation (9).

FIG. 5A shows a foot image 7 taken from a 98 kg male subject before transformation using equation (10). FIG. 5B shows the same image after optimal spatial warping using equations (10) and (9). Here the image 7 was registered to a template image 8 taken from a 47 kg female subject. FIGS. 5A and 5B show how images from subjects with diverse foot geometry can be transformed to a common template space via registration.

While the sum of squares error denoted by equation (8) is used to optimise the value of the vector q a more intuitive dissimilarity matrix may be used to obtain an indication of registration performance for reporting purposes. The degree to which two images do not overlap can be expressed using set notation:

$$ɛ = \frac{\vert {p}_{0} ⊕ {p}_{1}^{′} \vert}{\vert {p}_{0} ⋁ {p}_{1}^{′} \vert} \times 100 \% \qquad ( 14 )$$

### Where:

P₀ and p₁′ are images as described above;
   |pᵢ| the number of non-zero elements in the set pᵢ;
⊕ is the logical XOR operation; and
ν is the logical OR operator.

The denominator of equation (14) indicates a total number of pixels which are occupied by both the image p₀ and the image p₁′. The numerator of equation (14) indicates the number of pixels covered by one image or the other, but not both. Perfect registration is given when the value of c is 0%. This occurs when the numerator of equation (14) has a value of zero. Zero overlap (that is ε equals 100%) occurs when intersection between the two sets is the NULL set. The numerator of equation (14) is a binary image and is itself useful for confirming registration quality.

TABLE 1

| Data Processing Stage | Duration (s) | Accuracy (%) |
|---|---|---|
| Smoothing | 0.006 | N.A. |
| Intra-subject registration | 1.009 | 8.22 |
| Inter-subject registration | 0.721 | 14.71 |
| Statistical tests | 2.855 | N.A. |
| Resampling | 0.018 | N.A. |

Table 1 shows computational durations for various steps of the method described herein. It can be seen that smoothing and resampling are conducted negligibly quickly. Image registration required of the order of 1 second per image processed. Most of the total time is spent on registration. Inter-subject registration was faster than intra-subject registration because of an optimisation step size constraint.

Registration accuracy was of the order of 10%, indicating that, on average, approximately 10% of the template and source pixels did not overlap. The non-overlapping pixels were found exclusively on the foot periphery for intra-subject registration (as can be seen in FIG. 6 which is described in further detail below). For inter-subject registration, the non-overlapping pixels were also found in regions of the medial arch and phalanges.

The image of FIG. 6 is generated by applying an exclusive OR (XOR) operation across a collection of registered images. The image of FIG. 6 shows the frequency of non-overlapping pixel occurrence, the whiter a pixel the more frequently it was not contained in the intersection of the template of the source images.

Registration overlap ratios of approximately 90% are attributed to the spatial distribution of non-overlapping pixels due to pedobarographic resolution and also to anatomical factors. Since pedobarographic resolution is of the order of 5 mm it is expected that the foot perimeter can only be traced with an accuracy of 5 mm and even a rigid control object would yield an XOR perimeter image with 1 pixel thickness. This, coupled with inter-trial variability explains imperfect registration overlap. Inter-subject anatomical differences can similarly explain variability observed in the medial arch and toe regions after normalisation (as can be seen in FIG. 6).

Affine transformation of the type described above affects only gross foot shape and cannot, in general, yield perfect inter-subject registration. Non-linear spatial warping can be used to improve performance. By using a relatively high order low frequency 100 parameter discrete cosine transform non-linear warping algorithm and a robust evolutionary optimisation approach, for example, it is possible to increase overlap by a few percent. Indeed, it will be appreciated that any appropriate registration method may be used in place of those described above, as will be apparent to those skilled in the art.

The purpose of the aforementioned registration procedures is to allow for statistical tests to be conducted directly on the images at the pixel level as shown at steps S6 to S9 of FIG. 1. It is possible to use a range of statistical tests, and the actual test(s) selected will be application dependent.

At step S6 a general linear model is defined. The defined general linear model is specified by a numerical matrix termed a ‘design matrix’ that describes the experimental condition(s) with which each image is associated. For example, if there are five images from a first condition (e.g. pre-surgery) and five images from a second condition (e.g. post-surgery), the design matrix could be a 10×2 matrix where the two columns represent pre-surgery and post-surgery, respectively. The pre-surgery column would have values of ones in its first five rows, and the post-surgery column would have values of ones in its last five rows, and all other values would be zeros. Such a model properly differentiates between the two experimental conditions and describes the well-known two-sample t test. In addition to this simple model, the general linear model permits arbitrary linear experimental design including the use of one-sample t tests, analysis of variance (ANOVA) (F tests), multivariate analysis of variance (MANOVA), analysis of covariance (ANCOVA), multivariate analysis of covariance (MANCOVA), fixed effects analysis and mixed effects analysis, for example.

FIG. 7 is a graphical representation of an example design matrix. The columns represent experimental factors, and the rows represent experimental repetitions. Black regions have values of zeros and white regions have values of ones. The design matrix of FIG. 7 shows an experiment involving nine subjects and three walking conditions: normal walking, everted (or abducted) walking, and inverted (or adducted) walking. Ten consecutive trials of each condition were performed by all subjects, yielding a total of 270 images, as indicated along the vertical axis. This is an example of a fixed-effects model where each subject effect is treated as a fixed effect through the subject blocks on the right-hand side of the matrix. It is also an example of a non-random experimental design where the experimental conditions (the first three columns) contain single blocks of repetitions rather than having trials scattered randomly amongst each subject's 30 trials. A design matrix such as this must be specified at step S6 to use the general linear modeling approach.

The general linear model can be used to model factors that are not of experimental interest like time drift, for example. These are referred to as nuisance factors. The subject factors listed on the right side of the design matrix in FIG. 7 are nuisance factors. In this example, the differences between subjects (like body weight, for example) are not of interest with only the effects associated with normal, everted and inverted walking being of interest.

The general linear model is the most flexible approach to linear statistical modeling so is described here, but other statistical models could also be used at step S6.

Processing passes from step S6 to step S7. At step S7 the parameters that map experimental conditions to statistical images are estimated. In the case of a two-sample t test, for example, these parameters correspond to the mean pressures of the two experimental conditions. In this case there would be two parameters for each pixel in the statistical image, plus an additional variance parameter for each pixel. The parameters are computed using a least-squares approach as described in further detail below with reference to an example.

Processing passes from step S7 to step S8. At step S8 a statistical image is generated from the parameters (described below with reference to an example). In the statistical image, each pixel represents a single statistical value. The general linear model permits computation of a variety of statistics, including the t statistic (thereby generating what may be termed at t map), F statistic (generating what is may be termed an F map), and χ² statistic (generating what may be termed a χ² map).

Processing then passes to step S9 and statistical inference procedures are used to assess the statistical significance of the statistical values and/or the spatial processes in the statistical image. FIGS. 8A and 9A each show an arbitrary statistical image in which each pixel has an associated t value. Since there are multiple pixels, there are multiple t values, and thus the t values themselves form the images shown in FIGS. 8A and 9A.

A single t value does not convey statistical significance. Similarly a statistical image in which each pixel represents at value does not convey statistical significance. To compute the statistical significance, a statistical inference procedure is used to transform the t values making up the statistical image into associated probability (‘p’) value(s), thereby generating a step-wise statistical inference image as shown at step S11 of FIG. 1. The interpretation of statistical inference images and the corresponding p value(s) depends on the type of statistical inference process employed. For example, on one interpretation a p value of 1% (p=0.01) implies that, based on the observed experimental variance, there is a 1% chance that the experimental treatment could have produced the observed effect. Another interpretation of a p value of 1% is that if a random process generated the data, it would be expected that at value of this magnitude would be observed in only 1% of a large number of experimental replications. Therefore, when the p value is suitably small, there is reasonable confidence that this experimental effect did not result from a random process. The typical critical cut-off for statistical significance (sometimes referred to as ‘a’) is p=0.05. The experimenter-set a value to specifies the level of protection against Type I statistical error, also known as a ‘false positive’, the rejection of a null hypothesis when the null hypothesis is actually true.

FIG. 8B shows a binary image which highlights the pixels of FIG. 8A that have a p value of less than p=0.05, assuming an uncorrected p threshold. The p values for each pixel were computed individually based upon the t value for the respective pixel. It can be seen that the thresholding procedure has retained many pixels because of the treatment of each pixel individually.

Computing p values in this manner, for a single pixel t values, is a straightforward one-to-one mapping via a single well known statistical equation. But this procedure is statistically invalid because it both neglects the fact that many statistical tests have been conducted and because it neglects the spatial nature of the image data; pixels in neighbouring space have correlated behaviour. Thus a valid approach to conducting statistical inference on a statistical image involves techniques that are more complex than the well-known p value computation described above. Although a variety of methods can be used to generate p values, three classes of statistical inference are described herein which are particularly applicable to embodiments of the invention: (1) Bonferroni correction, (2) Random field theory, and (3) Non-parametric inference.

Before describing these procedures, it is important to realize that a general characteristic of all of these inference procedures is that they should account for the problem of multiple comparisons. Computing statistical images (of the type shown in FIGS. 8A and 9A) involves a large number of statistical tests, one for each image pixel. Choosing an uncorrected a value of 0.05 only protects against chance processes for one pixel, and therefore an uncorrected p threshold generally results in an overestimation of the significance of the statistical image processes. Multiple comparisons should therefore be accounted for in order to retain a valid a.

The Bonferroni correction is the simplest method for correcting for multiple comparisons. The Bonferroni correction reduces the p threshold such that the family-wise error rate is maintained at the desired value of a (5% in the described example) across the entire foot surface. The Bonferroni correction is computed as:

p_{critical}=1−(1−a)^{1/K} (15)

where K is the number of statistical tests or, equivalently, the number of non-zero pixels in the statistical image. As described above, FIG. 8B shows those pixels in FIG. 8A that have t values large enough to fall below an uncorrected p threshold of 0.05 (t=1.73 in this case). FIG. 8C shows those pixels that have t values larger than the Bonferroni-corrected threshold of t=4.24. It can be seen that far fewer pixels reached significance after the Boferroni correction relative to the uncorrected inference procedure.

It is worth noting that both the uncorrected and Bonferroni inference procedures produces stepwise-continuous statistical inference images which contain the t values of the raw statistical image shown in FIG. 8A in a collection of suprathreshold clusters (clusters of pixels having t values above the critical t threshold computed from a).

It will be appreciated that the statistical inference images shown in FIGS. 8B and 8C are stepwise in the sense that there are gaps between statistical clusters. The gaps represent image discontinuities (i.e. sharp falls in t values), but t values are continuous within the suprathreshold clusters (i.e. no sharp changes in t values pixel-to-pixel), hence the term a ‘stepwise-continuous’ image. In the case of the Bonferroni correction, and assuming an experimenter-set a=0.05, an interpretation of the statistical inference image shown in FIG. 8B is that there is a 5% probability that the pixels in each suprathreshold clusters could have occurred by chance”

The main weakness of the Bonferroni correction described above is that it does not properly take into account the spatial nature of the data. If a set of 500 pixels is processed, the Bonferroni correction would be identical irrespective of the spatial relationship of those pixels: the pixels could be scattered randomly in space off to infinity. However, foot pressure images and other pressure images are clearly not random spatial processes; they have spatial order in the form of a consistent foot shape.

Random Field Theory (RFT) takes advantage of this fact to either (i) provide a more realistic and less conservative correction for multiple comparisons or (ii) assign statistical significance to suprathreshold clusters rather than to individual pixels. Both of these RFT procedures depend on two characteristics of the original images: image smoothness, and spatial geometry.

Image smoothness is estimated from the residual images that are computed during estimation of the general linear model parameters (step S7 of FIG. 1). Each residual image E, the calculation of which is described below with reference to equation (35) are first normalized by the pixel standard errors (s), the calculation of which is described below with reference to equation (34) to produce normalized residual images

$${Z}_{i} = \frac{{E}_{i}}{s} \qquad ( 16 )$$

Next the covariance matrix Λ of residual spatial derivatives may be computed using:

$${Λ}_{k} = [ \begin{matrix}var ( \frac{\partial {Z}_{k}}{\partial x} ) & cov ( \frac{\partial {Z}_{k}}{\partial x} , \frac{\partial {Z}_{k}}{\partial y} ) \\ cov ( \frac{\partial {Z}_{k}}{\partial x} , \frac{\partial {Z}_{k}}{\partial y} ) & var ( \frac{\partial {Z}_{k}}{\partial y} )\end{matrix} ] \qquad ( 17 )$$

where k indexes the non-zero pixels and where x and y indicate the spatial directions where var is a function providing a measure of variance and cov is a function providing a measure of covariance. Finally, global smoothness is estimated by the FWHM:

$$FWHM = \sqrt{( 4 log 2 ) \frac{1}{K} {\sum }_{k} {\vert {Λ}_{k} \vert}^{- 0.5}} \qquad ( 18 )$$

Here the FWHM represents the ‘full width at half maximum’ of a Gaussian kernel that, when convolved with the random field data, would produce the same smoothness as the observed residuals. Hence the FWHM provides a direct estimation of image smoothness.

The RFT inference procedures also depend on spatial geometry, which may be defined algorithmically by pixel connectivity. For two dimensional images the RFT-relevant spatial geometry is summarized by three parameters R₀, R₁, and R₂, termed ‘resolution element counts’ or ‘resel counts’:

R₀=K−(Eₓ+E_{y})+F (19)

R₁=(Eₓ+E_{y}2F)/FWHM (20)

R₂=F/FWHM² (21)

where Eₓ and E_{y} are the number of pairs of adjacent pixels in the x- and y-directions, respectively, and where F is the number of four-pixel squares in the search area. The R parameters thus define the search space up to the number of dimensions (in this case two) and measure the area (R₂), the perimeter (R₁), and the Euler characteristic (R₀). These ‘resel count’ parameters may be regarded as the effective number of independent observations in an image dataset, having accounted for smoothness. Thus the smoother the field (the larger the FWHM), the fewer the number of independent observations.

After computing image smoothness (via the FWHM) and image geometry (via the resel counts), RFT-based inference can proceed. As described above, this can happen in one of two ways, (i) by computing a RFT-corrected threshold to account for multiple comparisons, or (ii) by computing the statistical significance of suprathreshold clusters following an arbitrary experimenter-set t threshold.

The former RFT procedure is analogous to the Bonferroni correction in that it computes a critical t threshold h, and pixels with t values above the threshold h are deemed to be statistically significant. The threshold h is computed as follows:

$$\begin{matrix}P ( {t}_{max} > h ) \approx {\sum }_{D = 0}^{2} {R}_{D} {ρ}_{D} ( t ) & ( 22 ) \\ {ρ}_{0} ( t ) = {\int }_{t}^{∞} \frac{Γ ( \frac{v + 1}{2} )}{Γ ( \frac{v}{2} ) \sqrt{v π} {( 1 + \frac{{u}^{2}}{v} )}^{- 0.5 ( v + 1 )} d u} & ( 23 ) \\ {ρ}_{1} ( t ) = \frac{\sqrt{4 log 2}}{2 π} {( 1 + \frac{{t}^{2}}{v} )}^{- 0.5 ( v - 1 )} & ( 24 ) \\ {ρ}_{2} ( t ) = \frac{4 log 2 Γ ( \frac{v + 1}{2} )}{{( 2 π )}^{1.5} Γ ( \frac{v}{2} ) \sqrt{\frac{v}{2}}} {t ( 1 + \frac{{t}^{2}}{v} )}^{- 0.5 ( v - 1 )} & ( 25 )\end{matrix}$$

where R_{D} are the resel counts, ρ_{D} are Euler characteristic densities, ν is the number of degrees of freedom in the statistical model (the calculation of which is shown at equation (36) below), and Γ is the gamma function. Here P(tₘₐₓ>h) is the theoretical probability that the maximum t value in a statistical image exceeds a threshold h.

Given an experimenter-set a, one finds the critical threshold h by iteratively varying the parameter t such that the right side of equation (22) is equal to a. This procedure results in a generally less conservative threshold as compared with the Bonferroni correction, producing a slightly broader suprathreshold set as shown in FIGS. 8D and 9B. Assuming a=0.05, the statistical significance of the statistical inference image shown in FIG. 8D is as follows: given the observed image smoothness and spatial geometry of the search area, there is a 5% probability that these suprathreshold pixels could have occurred by chance.

The main weakness of the RFT inference procedure described above is that statistical significance is assigned pixel-by-pixel, a process which does not take advantage of the spatial clustering of suprathreshold pixels (indicated in FIG. 8D, for example). The second RFT-based inference procedure employs an arbitrary experimenter-set threshold h and then computes the probability that a particular suprathreshold cluster could have occurred by chance given its spatial extent. Firstly, the expected numbers of excursion set pixels (N) and clusters (m) are computed as:

E{N}=Aρ₀(h) (26)

E{m}=Aβ₂(h) (27)

where A is the search area normalized by FWHM². The probability that the largest suprathreshold cluster contains n or more pixels [P(nₘₐₓ>n)] is:

P(nₘₐₓ>n)=1−exp(E{m}e^{-Bn}) (28)

B=Γ(2)E{m}/E{N} (29)

These probability values are then computed for each suprathreshold cluster based on their size k and may be indicated next to the clusters on the statistical inference image, as shown in FIGS. 8E and 9C. Assuming a=0.05, the interpretation of statistical significance is as follows: “given the observed image smoothness, spatial geometry, and threshold h, there is a p % probability that a suprathreshold statistical cluster of the same size could have occurred by chance.” Here p is the computed p value of the specific cluster.

Note that the equations for the second RFT-based inference procedure were derived for Gaussian fields, so only give an approximate solution for t fields with high degrees of freedom. More accurate results for t fields and other statistical fields are given in the statistical literature for example, [Cao, J., 1999. The size of the connected components of excursion sets of χ2, t and F fields. Advances in Applied Probability 31(3) 579-595]. However, the equations described above are appropriate for cases of high degrees of freedom.

The final class of inference procedures is non-parametric inference. A potential weakness of the RFT procedures described above is that they rely on statistical parameters to describe the underlying expectations of image randomness. Specifically, RFT uses the pixel-level ‘mean’ and ‘standard-deviation’ parameters to define the statistical distribution. Such parametric approaches are powerful but rely on various assumptions including, most critically, normal distribution of residuals (as included in equation 35). When foot pressure images contain areas of geometrical disparity (e.g. comparing a high-arched subject to a low-arched subject), this assumption will be violated because there are many null observations for the high-arched subjects in the areas where the arch does not contact the ground.

For these types of situations, non-parametric (NP) inference is more appropriate. Starting with an experimental statistical image (an ‘E-image’), examples of which are shown in FIGS. 8A, 9A, NP procedures employ Monte-Carlo simulations to compute a set of hypothetical statistical images CH images') by randomly permuting the experimental parameters applied during the creation of the general linear model as described above. For the E-image and each H-image, a statistical value is computed, for example the size of the largest suprathreshold statistical threshold. The H-images and the E-image thereby map out an experimental probability distribution of the computed statistic. The significance of the E-image statistic is then determined directly from this experimental probability distribution by determining how extreme its statistical value is compared to the randomly generated H-image values. Assuming a=0.05, NP-based inference images may be interpreted as follows: given the threshold h, there is a p % probability that a suprathreshold statistical cluster of the same size could have occurred by chance.

For NP procedures, one may optionally smooth the underlying variance field to produce a smoother statistical image (as has happened with the image shown in FIG. 8A), a process which can produce larger supra-threshold clusters in cases where overly-conservative pixel variance estimates would preclude certain pixels from these clusters. In other words, since NP inference procedures do not explicitly depend on the parameterised variance, one can smooth the variance without affecting the validity of the inference procedures.

Experiments carried out using the techniques set out above are now described. Left foot pedobarographic records were collected from nine healthy subjects (5 males, 4 females, age: 29.8±7.7 years) using a 0.5 meter foot scan 3D system (available from RS Scan, Belgium). Three experimental conditions were investigated: normal feet, abducted feet, and adducted feet. Other gait parameters (for example walking speed) were not precisely controlled. Subjects performed ten consecutive trials of each condition yielding a total of 270 pedobarographic records (30 for each subject). Maximum sensor values were extracted from the stance phase time series to form a single image for each trial. A foot image with arbitrary size, shape and orientation is transformed using the smoothing, realignment and normalisation techniques described above. Images on which statistical tests were performed were contained in a 53 by 22 grid of which 742 pixels contained the feet. Inter-subject and intra-subject tests of the type described above were carried out.

TABLE 2

| | Normal | Abducted | Adducted |
|---|---|---|---|
| Mean | 0 | −32.0 | +26.3 |
| Std | (1.8) | (7.9) | (10.3) |

Foot orientation in abducted and adducted walking, as measured by principal axis orientation, differed from a normal orientation by approximately 30 degrees, as indicated in table 2. Assuming non-circular statistics because of small angular values, one-way ANOVA confirmed an effect of experimental treatment.

As described above, with reference to step S6 of FIG. 1, a general linear statistical model:

Pᵢₖ=gᵢⱼβⱼₖ+hᵢₗγₗₖ+eᵢₖ (30)

is generated, where pᵢₖ is the pressure observation at the k^{th} pixel in pressure record i. Here, i indexes the I pressure records, k indexes the K pixels containing the feet, j indexes the J experimental factors and l indexes the L (9 in this example) subjects. The errors (eᵢₖ) are assumed to be independent, equal, and normally distributed across conditions and subjects, but not across pixels. Explanatory variables gᵢⱼ and hᵢₗ correspond to treatment effects and nuisance factors (subject effects), respectively. βⱼₖ and γₗₖ are unknown parameters.

As described above with reference to step S7 of FIG. 1, to compare the images between experimental conditions, one must first solve for the unknown parameters in equation (30). This can be done easily using linear algebra. The model of equation (30) can be expressed concisely as:

P=Gβ+e (31)

where P is the mean-corrected pressure data matrix, G is the binary experimental design matrix shown in FIG. 7, β is the parameter matrix (including nuisance factors), and e is the error matrix. The data P are mean corrected within pixels so that the model does not require a superfluous constant term. In general it is unnecessary to mean correct the data P as a constant column of ones could be added to G to make mean-correction unnecessary. To compute the values of the unknown parameters, least-squares estimates of β (denoted ‘b’) are obtained by:

b=G⁺P=(G^{T}G)⁻¹G^{T}P (32)

where G⁺ is the pseudo-inverse of G. At step S8 of FIG. 1, the t statistic is computed for each pixel as:

$$\begin{matrix}{t}_{k} = \frac{{cb}_{k}}{{s}_{k}} & ( 33 ) \\ {s}_{k}^{2} = \frac{{E}_{k}}{v} {c ( {G}^{T} G )}^{- 1} {c}^{T} & ( 34 ) \\ E = {( P - Gb )}^{T} ( P - Gb ) & ( 35 ) \\ v = I - rank ( G ) & ( 36 )\end{matrix}$$

where c is a (1×(J+L)) contrast vector, bₖ is the k^{th} column of b, sₖ is the standard error estimate for each pixel, and Eₖ is the kth diagonal element of the squared residuals E. Two contrast vectors were tested: [−1 1 0 0] and [−1 0 1 0], respectively representing cases where abducted and adducted pressures exceeded normal pressures; here 0 is the (1×8) null vector corresponding to the eight subject nuisance factors. As described above the t values themselves form an image that is termed a ‘t map’. This statistical image has the same resolution as the original pedobarographic images and indeed has the 2D shape of the original foot or feet. However, unlike the original pedobarographic images whose pixel values represent only pressure values, the pixels of at map represent the effects of a linear combination of the experimental factors. FIGS. 10A, 10B, and 10C respectively show mean images obtained in experimental conditions of, normal walking, abducted walking and adducted walking. It can be seen that FIG. 10B shows increased pressure medially under the first metatarsal head and hallux in abducted walking as compared to normal walking shown in FIG. 10A. Adducted walking represented by the image of FIG. 10C is associated with elevated pressure under the lateral metatarsal heads and also with greater contact under the longitudinal arch under the lateral phalanges. The statistical significance of these trends is confirmed by t maps shown in FIGS. 11A and 11B. It can be seen in FIG. 11A that there is increased pressure across the medial foot in abducted walking while there is increased pressure under the lateral foot in adducted walking (as shown in FIG. 11B). The peripheral ‘noise’ can be removed if one conducts RFT-based inference because the size of the noise clusters is small. It can be seen that the images shown in FIGS. 11A and 11B, and the images in FIGS. 8E and 9C, provide a convenient mechanism for comparing pedobarographic images.

In addition to performing clinical/laboratory analysis of pedobarographical data, it will be appreciated that the methods presented above for pedobarographical image analysis have more general application. For example, one application of the present invention is as a method of identification of individuals, for use, for example, at airports. A database of individuals may be maintained which stores, for each individual, a plurality of processed images and a statistical image generated from the plurality of pedobarographic images taken from that individual using the methods as described above. To identify an individual, further pedobarographic images are obtained and compared with the both the plurality of processed images and the statistical images stored in the database, to determine if there is a match.

FIG. 12 is a flow chart showing a process that may be carried out to identify an individual using the present invention, assuming the existence of a database storing details of individuals with corresponding statistical images taken from pedobarographic images of those individuals' feet.

Referring to FIG. 12, at step S12 at least one pedobarographic image of one of an individual's foot or feet is obtained. The pressure images may be obtained using any appropriate method, for example, by asking an individual to walk across a pressure plate containing appropriate sensors. Once at least one suitable image is obtained, processing passes to step S13 at which the obtained images are registered to a template image to which all subject images in a database have been registered. Registration of the images may be conducted as described above. It will be appreciated that, as described with reference to FIG. 1, prior to registration the obtained image may be smoothed to remove artefacts from the obtained image. From step S13, processing passes to step S14 at which the registered images are compared to each image and/or statistical image in the database and, if necessary, to each processed image, to determine a closest match. The comparison of the obtained images with the images in the database may be performed using pattern recognition techniques, for example, a k-nearest neighbour algorithm (k-NN). Alternatively the statistical procedures described above could be employed to determine the confidence of a match. It will be appreciated that further refinement of returned matches may be performed to further narrow search results.

The process described with reference to FIG. 12, has been performed on a sample size of 24 healthy young subjects with 10 database repetitions each and obtained an identification accuracy of 100%.

Another application could analyse the pressure fields between a subject and a mattress or wheelchair to detect subject movement. This could be done in a real time implementation of the present invention, where significant changes in pressure fields will be indicative of subject movement and will thereby help to determine if the patient requires assistance.

The present invention may further be used in the area of vehicle design, for example, in the analysis of the interface between vehicle doors and the vehicle frame, or between a wiper surface and a windscreen. Indeed, it will be appreciated that, generally, the present invention has application where the ability to analyse pressure fields is desired.

The techniques for processing pedobarographic data described herein can also be usefully applied to three dimensional images. In particular, techniques are now described which allow the visualization of a three dimensional spatiotemporal volume of data, an example of which is shown in FIG. 13. FIG. 14 shows processing carried out to generate the visualization of FIG. 13.

Referring to FIG. 14, at step S15 a three dimensional spatiotemporal pressure image is received. Such three dimensional data are produced by any perobarographic hardware system that samples consecutively in time, and typical commercial systems record 2D images at 500 Hz. For example, a typical stance phase of 0.6 seconds during human walking yields approximately 300 2D images. These 2D images may be stacked to form a single three dimensional spatiotemporal volume.

At step S16 the received image is smoothed by convolving the three dimensional image with a three dimensional Gaussian kernel. At step S17 a number of isosurfaces are computed by algorithmically interpolating the smoothed image, each isosurface being associated with a particular pressure. Three isosurfaces are shown in FIG. 13. A first isosurface 10 represents areas having a pressure of 1Ncm⁻², a second isosurface 11 represents areas having a pressure of 5Ncm⁻², and a third isosurface 12 represents areas having a pressure of 10Ncm⁻². Each isosurface is given associated properties (e.g. colour, transparency and texture at step S18 of FIG. 14. At step S19 lighting, camera, and other environmental parameters are set so as to provide a visualization having the desired interpretive properties. The visualization is then rendered and displayed to a user in an appropriate form at step S20. Although FIG. 13 depicts a visualization of a spatiotemporal volume of pressure values from a single walking trial, the same visualization procedures may be applied to 3D statistical images generated using the methods described above, an example of which is shown in FIG. 15

It will be understood that the specific techniques and transformations are provided by way of example only, and that the ordering of the techniques may be altered, and other suitable techniques may be similarly employed. For example, the statistical analysis techniques are presented solely for exemplification. Indeed, various modifications can be made to the described embodiments without departing from the scope of the present invention.

1-41. (canceled)

42. A method of processing a pressure image, the method comprising:
receiving a plurality of first continuous pressure images;
processing each of said first continuous pressure images to generate a respective second continuous pressure image; and
generating a continuous statistical image representing a characteristic of the first pressure images by processing said second continuous pressure images.

43. A method according to claim 42, wherein processing said first continuous pressure image comprises applying a smoothing operation to said pressure image.

44. A method according to claim 43, wherein applying said smoothing operation to said first pressure image comprises filtering the received image.

45. A method according to claim 44, wherein applying said smoothing operation to said first pressure image further comprises applying a predetermined threshold to the filtered image.

46. A method according to claim 44, wherein applying said smoothing operation to said first pressure image further comprises performing morphological operations on the image to which the predetermined threshold has been applied.

47. A method according to claim 42, wherein processing said first pressure image comprises registering said first pressure image to a template image.

48. A method according to claim 47, wherein registering said first pressure image to a template image comprises performing at least one of a translation and rotation of the first pressure image.

49. A method according to claim 47, wherein registering said first pressure image to a template image comprises:
generating initial image transformation parameters; and
optimizing said initial image transformation parameters.

50. A method according to claim 47, wherein processing said first pressure image further comprises spatially warping the first pressure image with reference to a template image.

51. A method according to claim 50, wherein said spatial warping comprises applying a linear or nonlinear spatial transformation to the first pressure image.

52. A method according to claim 50, wherein said spatial warping comprises scaling the pressure image.

53. A method according to claim 52, wherein said scaling applies respective scaling factors in two perpendicular directions.

54. A method according to claim 42, wherein said characteristic of said first pressure image is a comparison with one or more predetermined reference images.

55. A method according to claim 42, wherein said characteristic of said first pressure images is a comparison of said first pressure images.

56. A method according to claim 42, wherein said plurality of first pressure images are taken from a single subject.

57. A method according to claim 42, wherein said plurality of first pressure images are taken from a plurality of subjects.

58. A method according to claim 42, wherein said generated continuous statistical image has a resolution which is substantially equal to a resolution of each first pressure image.

59. A method according to claim 42, wherein said generated continuous statistical image is a t-map, F-map, or other statistical map.

60. A method according to claim 42, further comprising:
processing said statistical image to generate a further statistical image.

61. A method according to claim 60, wherein said processing to generate a further statistical image comprises carrying out statistical inference on said statistical image.

62. A method according to claim 61, wherein said further statistical image is a stepwise continuous statistical inference image representing statistical significance of a characteristic of a plurality of first continuous pressure images.

63. A method according to claim 61, wherein said statistical inference processes t values of said statistical image generated by at test and generates probability values.

64. A method according to claim 61, wherein said statistical inference takes into account smoothness of said statistical image and/or at least one geometric property of said statistical image.

65. A method according to claim 61, wherein said statistical inference comprises techniques based upon random field theory, a Bonferroni correction and/or non-parametric inference.

66. A method according to claim 42, wherein said first continuous pressure image is a plantar foot surface pedobarographic image.

67. A method according to claim 66, wherein each of said first plantar foot surface pedobarographic images and said second plantar foot surface pedobarographic images is an image of an entire plantar foot surface.

68. A method according to claim 66, further comprising:
generating a plurality of statistical images each representing a characteristic of one or more pressure images;
receiving an input pressure image; and
selecting one of said plurality of statistical images based upon said input pressure image.

69. A method according to claim 68, further comprising:
storing identification data for each of said plurality of said statistical images; and outputting identification data for said selected one of said plurality of statistical images.

70. A method according to claim 42, wherein each of said first continuous pressure images is an image of a pressure field between a first object and a second object.

71. A method according to claim 70, wherein each of said first continuous pressure images is an image of a pressure field between a subject and a mattress.

72. A method according to claim 70, wherein each of said first continuous pressure images is an image of a pressure field between a subject and a seating apparatus.

73. A computer readable medium carrying a computer program comprising computer readable instructions configured to:
receive a plurality of first continuous pressure images;
process each of said first continuous pressure images to generate a respective second continuous pressure image; and
generate a continuous statistical image representing a characteristic of the first pressure images by processing said second continuous pressure images.

74. A computer apparatus comprising:
a memory storing processor readable instructions; and
a processor configured to read and execute instructions stored in said program memory;
wherein said processor readable instructions comprise instructions controlling the processor to:
receive a plurality of first continuous pressure images;
process each of said first continuous pressure images to generate a respective second continuous pressure image; and
generate a continuous statistical image representing a characteristic of the first pressure images by processing said second continuous pressure images.

75. A method for displaying pressure data comprising a plurality of sets of two-dimensional pressure data, the method comprising:
displaying a three dimensional volumetric representation of said pressure data, wherein first and second dimensions of said three dimensional volumetric representation represent spatial data, and a third dimension of said three dimensional volumetric representations represents temporal data.

76. A method according to claim 75, further comprising graphically rendering said three dimensional volumetric representation.

77. A method according to claim 75, further comprising:
computing surfaces from said data representing a predetermined pressure or range of pressures; and
generating graphical data indicating said determined surfaces.

78. A method according to claim 75, wherein the three dimensional volumetric representation is a three dimensional statistical image generated from a plurality of said pressure data.
